(19) United States
(12) Patent Application Publication
(10) Pub. No.: US 2015/0303741 A1
(43) Pub. Date: Oct. 22, 2015

(54) WIRELESS ENERGY TRANSMISSION

(71) Applicant: QUALCOMM Incorporated, San Diego, CA (US)

(72) Inventors: Rahul Malik, San Diego, CA (US); Peerapol Tinnakornsrisuphap, San Diego, CA (US); Bibhu Prasad Mohanty, San Diego, CA (US)

(73) Assignee: QUALCOMM Incorporated, San Diego, CA (US)

(21) Appl. No.: 14/256,576

(22) Filed: Apr. 18, 2014

(51) Int. Cl. H02J 17/00

(52) U.S. Cl. CPC H02J 17/00; H04W 84/12

(57) ABSTRACT

An energy transmitting device (e.g., access point) can transmit an energy signal to a wireless device. The wireless device can obtain energy from the energy signal. The energy signal may be transmitted via an unused frequency sub-range of a frequency range associated with a communication signal. In one embodiment, the energy signal may occupy a frequency sub-range in unused frequencies of an orthogonal frequency division multiplexed (OFDM) signal transmission. The energy signal may be transmitted in a manner that coexists without interfering with traditional communication signals. Various control/configuration settings may be used to enable or disable the energy signal, for example, based on capability of a wireless device to harvest energy from the energy signal or in accordance with a schedule.

### BACKGROUND

Embodiments generally relate to the field of wireless communication systems, and, more particularly, to wireless energy transmission from an energy transmitting device to a wireless device.

Increasingly, wireless devices are being deployed in wireless communication systems. Wireless devices are typically connected via a wireless network (such as wireless local area network (WLAN)) to communicate with other devices or network-based resources. Wireless devices may include computers (including laptops, personal computers, tablets, and the like), phones, game systems, appliances, sensor/actuator devices, or other types of devices that are capable of using a wireless network to communicate with another device. As one example, low-cost sensor/actuator devices may be used with applications such as building automation, smart-energy and resource management, amongst others. Furthermore, some wireless devices are expected to be deployed in hard-to-reach places or where a wired power outlet is not available.

Wireless devices typically consume power to communicate via the wireless network. Maintaining sufficient power for a wireless device may require frequent charging, a power source, or a larger battery. While most applications typically involve the device intermittently waking up and transmitting a few bytes of data, and communication protocols and devices have been optimized to provide for many months of operation on batteries, diagnosing battery failure and replacing batteries may be difficult or time consuming. Several devices and systems harness ambient energy to prolong battery life. Such systems often rely on harvesting light, mechanical energy, temperature gradients and stray radio frequency (RF) energy. However, the available energy from ambient sources may not always be present in the device environment and the energy density of these sources is typically extremely low.

### SUMMARY

Various embodiments are described for providing energy to a wireless device via an energy signal transmitted from an energy transmitting device (such as an access point of a wireless network). In one embodiment, an energy transmitting device may transmit an energy signal via an unused portion of a frequency range associated with a communication signal, wherein the energy signal provides energy to the wireless device.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an example system in which an energy signal is transmitted from an energy transmitting device to a wireless device in accordance with an embodiment of this disclosure.

FIG. 2 depicts an energy signal transmitted with a communication signal in accordance with an embodiment of this disclosure.

FIG. 3 is a system diagram of an example energy transmitting device capable of transmitting an energy signal in accordance with an embodiment of this disclosure.

FIG. 4 is a system diagram of an example wireless device capable of receiving an energy signal in accordance with an embodiment of this disclosure.

FIG. 5 is a flow diagram associated with transmission of the energy signal in accordance with an embodiment of this disclosure.

FIG. 6 is a flow diagram in which power of an energy signal may be adjusted in accordance with an embodiment of this disclosure.

FIG. 7 depicts an example system in which an energy transmitting device may selectively transmit the energy signal to one or more wireless devices in accordance with an embodiment of this disclosure.

FIG. 8 is a flow diagram in which transmitting the energy signal may be dependent on capability of wireless devices and scheduling in accordance with an embodiment of this disclosure.

FIGS. 9A-9E illustrate example timing diagrams with various example schedules in accordance with various embodiments of this disclosure.

FIG. 10 depicts an example message format in accordance with an embodiment of this disclosure.

FIG. 11 is a block diagram of one embodiment of an electronic device including a wireless energy unit for implementing various embodiments of this disclosure.

### DESCRIPTION OF EMBODIMENT(S)

The description that follows includes exemplary systems, methods, techniques, instruction sequences and computer program products that embody techniques of the present disclosure. However, it is understood that the described embodiments may be practiced without these specific details. For instance, although examples refer to particular WLAN embodiments, the embodiments described may be used in other types of wireless networks including personal area networks, wireless automation systems, manufacturing, or wireless wide area networks. Additionally, although examples refer to an orthogonal frequency division multiplexed (OFDM) wireless system, the disclosure may be applied to other suitable communication systems. In other instances, well-known instruction instances, protocols, structures and techniques have not been shown in detail in order not to obfuscate the description.

This disclosure describes an energy signal transmitted from an energy transmitting device to a wireless device. The energy transmitting device may be, for example, an access point, computer, or any device having battery or wired power and an energy signal transmitter available to transmit an energy signal to a wireless device. The wireless device may be a wireless station, accessory, or other device having a wireless receiver and configured to obtain energy from the energy signal. The energy signal may be in addition to other transmitted or received communication signals. The communication signal and energy signal may be transmitted concurrently or separately. The energy signal may occupy a portion (e.g., a frequency sub-range) that is a subset of a larger frequency range typically associated with the communication signal. In one embodiment, the energy signal occupies a small portion or frequency sub-range at the center of an OFDM signal frequency range. The energy signal may be transmitted in such a way that it does not interfere with the communication signal and can be filtered at the wireless device. In other words, the energy signal may be transmitted in a manner that coexists with traditional communication signals. In one embodiment, wireless devices may not be capable of detecting the energy signal or obtaining energy from the energy signal. The energy signal may be transmitted in a way that does not impair communication associated with non-capable devices (i.e., those devices not capable of utilizing the energy signal) that are operating in the vicinity of the energy transmitting device.

Various control or configuration settings associated with the energy signal are disclosed. For example, the energy signal may be enabled or disabled according to a schedule—such as periodic energy signal, a night-time energy transmitting schedule, a burst schedule, or during known idle periods of the communication channel. The energy signal may be enabled or disabled in response to changes in channel activity or channel conditions. For example, the energy signal may be disabled upon detection of a packet preamble such that the energy signal is not transmitted during reception of a data portion of the packet. The energy signal may resume during idle periods of the communication signal. In some embodiments, the energy signal may be transmitted concurrently with a transmitted communication signal.

The energy signal may be enabled or disabled based at least in part on whether a wireless device is capable of obtaining the energy from the energy signal. For example, the energy signal may be disabled if a wireless device that is incapable of obtaining the energy from the energy signal has been detected in the vicinity of the transmitter. In an embodiment, the energy signal may be directed to a particular receiver using transmit beam-forming. In an embodiment, the energy signal may contain embedded information such as a synchronization signal, paging signal, clock signal, or the like.

In one embodiment, the energy signal may be enabled or disabled based at least in part on whether a communications capability of a wireless device may be adversely affected by the presence of the energy signal. For example, if a non-supporting wireless device (also referred to as non-capable wireless devices, or legacy wireless devices, in this disclosure) may be impaired by the transmission of the energy signal, the energy signal may be disabled when the non-supporting wireless device is within a wireless coverage range of an energy transmitting device. An energy transmitting device may transmit the energy signal when the quantity of non-supporting wireless devices within a wireless coverage range of the energy transmitting device is below a threshold.

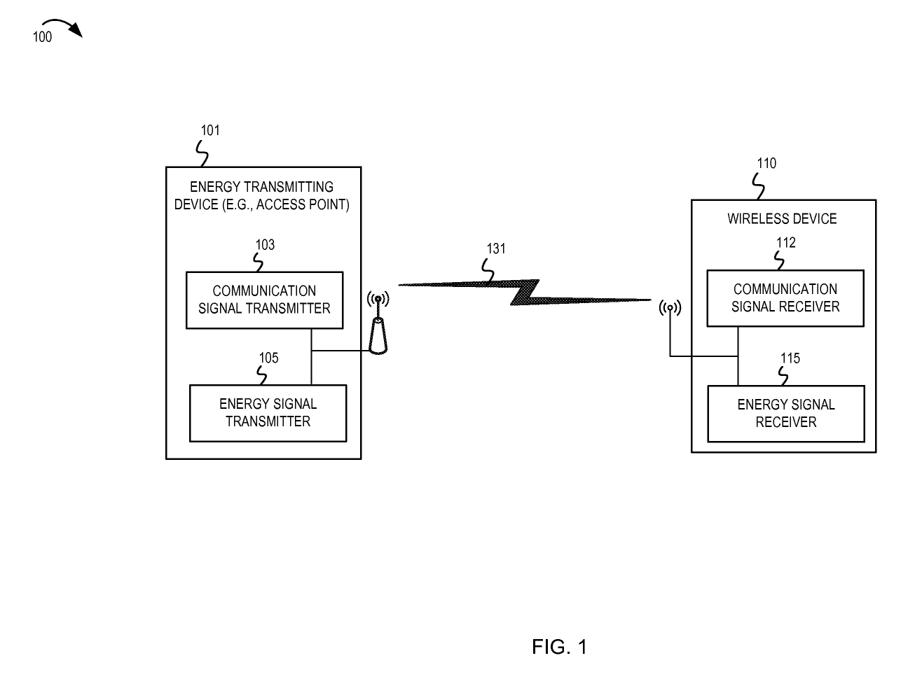

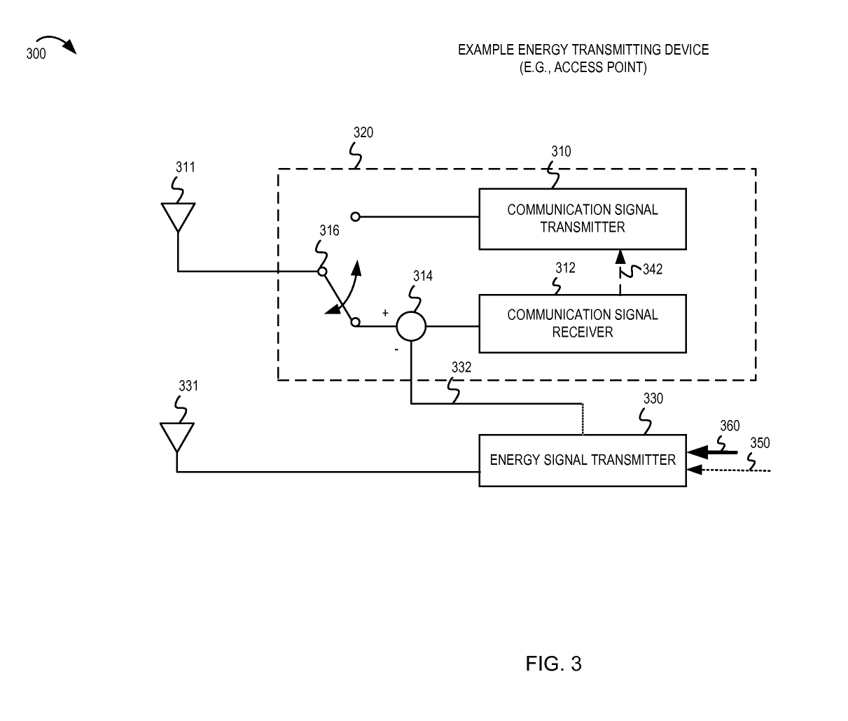

FIG. 1 depicts an example system 100 in which an energy signal is transmitted from an energy transmitting device 101 to a wireless device 110 in accordance with an embodiment of this disclosure. The energy transmitting device 101 includes a communication signal transmitter 103 and an energy signal transmitter 105. In some embodiments, the communication signal transmitter 103 and energy signal transmitter 105 may share components of a transmit chain, such as an antenna. However, in other embodiments, each of the communication signal transmitter 103 and energy signal transmitter 105 may have separate physical components collocated at the energy transmitting device 101. Further description of the energy transmitting device 101 is provided in FIG. 3. In some embodiments, the communication signal transmitter 103 of the energy transmitting device 101 may be part of a communication unit having both transmitting and receiving capability. For example, the communication signal transmitter 103 may be a communication signal transceiver.

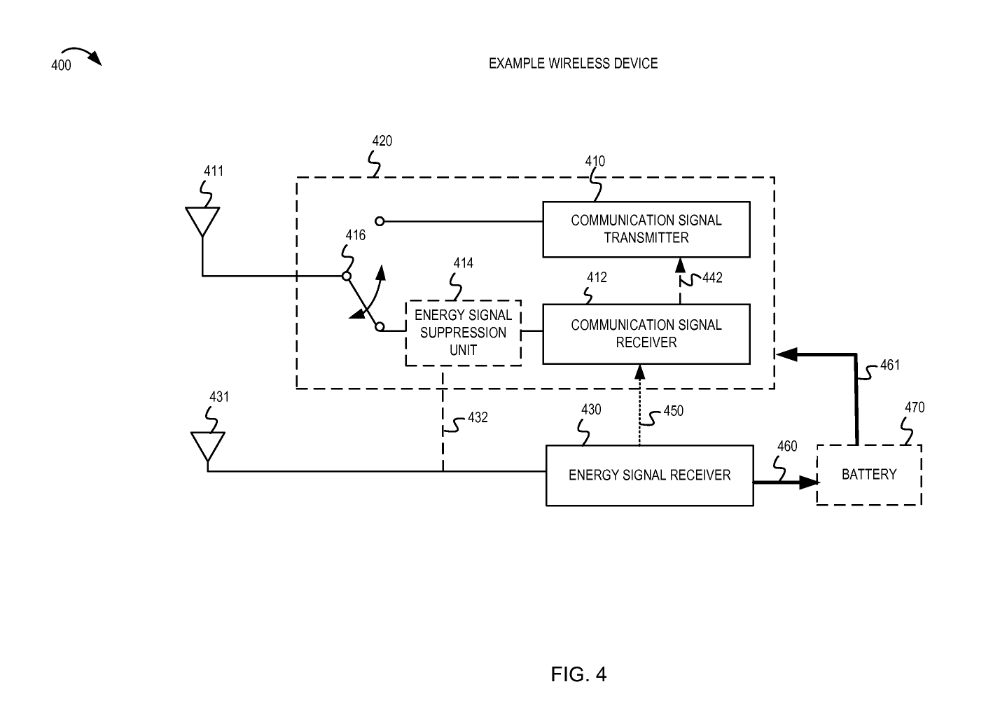

The wireless device 110 includes a communication signal receiver 112 and an energy signal receiver 115. Similar to the energy transmitting device 101, the components of the communication signal receiver 112 and energy signal receiver 115 may be shared or separate. The wireless device 110 is further described in FIG. 4. In some embodiments, the communication signal receiver 112 of the wireless device 110 may be part of a communication unit having both transmitting and receiving capability. For example, the communication signal receiver 112 may be a communication signal transceiver.

As with traditional communication systems, the communication signal transmitter 103 is capable of transmitting a communication signal (not shown) to the communication signal receiver 112. The communication signal may be considered traditional communication, and may be referred to by other terms such as data signal, data transmission, or the like.

Depicted in FIG. 1, the energy signal transmitter 105 is transmitting an energy signal 131 to the energy signal receiver 115. The energy signal 131 may provide energy for the wireless device 110. The energy signal receiver 115 may obtain (may also be referred to as “harvest” or “extract”) energy from the energy signal. The energy may be used to charge a battery or for immediate or future consumption by the wireless device 110. For example, in one embodiment, the energy harvested from the energy signal 131 by the energy signal receiver 115 may be used by the communication signal receiver 112 to process a communication signal (not shown).

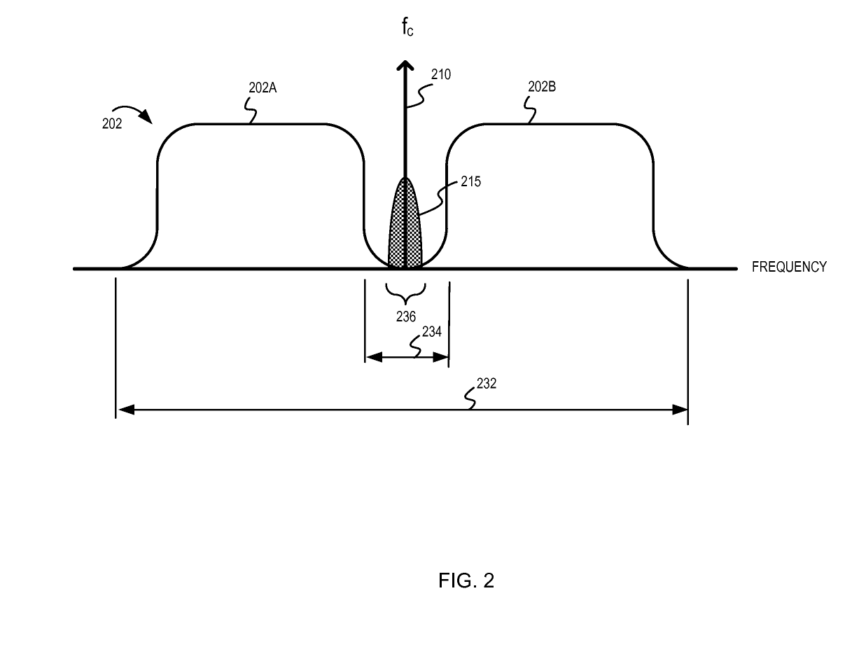

In some embodiments, the energy signal 131 may be transmitted independently from a communication signal, as shown in FIG. 1. However, the energy signal may occupy an unused portion of a frequency range associated with communication signals between the energy transmitting device 101 and wireless device 110. For example, the typical communication signals between energy transmitting device 101 and wireless device 110 may be OFDM waveforms having a predetermined range of frequencies established for the wireless communication channel between energy transmitting device 101 and wireless device 110. However, the energy transmitting device 101 and wireless device 110 may be configured to refrain from transmitting communication signals via unused or reserved frequencies within the predetermined range of frequencies. The energy signal may be transmitted by the energy signal transmitter 105 using a portion of the unused frequencies, as shown in FIG. 2.

FIG. 2 depicts an energy signal 215 transmitted via an unused portion of a frequency range associated with a communication signal 202 in accordance with an embodiment of this disclosure. In FIG. 2, a frequency range 232 is associated with OFDM transmissions. However, OFDM transmission schemes typically place a null at the center frequency 210. For example, in the context of an IEEE 802.11n OFDM receiver the center frequency and the adjacent tones on either side are not used for communication signals. In FIG. 2, a frequency sub-range 234 includes the center frequency 210 and other adjacent frequencies that are not used for the OFDM communication signal 202. The OFDM communication signal 202 may include a first OFDM portion 202A and a second OFDM portion 202B that may occupy the frequency range 232 except for the frequency sub-range 234 of suppressed frequencies. The suppressed frequencies may also be referred to as unused, reserved, or guard frequencies.

OFDM communication systems may suppress the communication signals at the center frequency 210 (also referred to as carrier frequency) to allow for the transmitter to distribute the communication signal energy to other frequencies. Furthermore, communication signals transmitted at the center frequency 210 may result in down-conversion to direct current (DC) which can cause problems in decoding the communication signal, such as biasing, base-line wander, loss of analog-to-digital conversion resolution and subsequent loss of fixed-point resolution. To avoid transmission of communication signals that would become DC at the receiver, an OFDM transmission scheme may suppress transmissions at the center frequency and adjacent frequencies. The suppressed frequency sub-range 234 provides a margin for filters with adequate roll-off to suppress any DC after down conversion at the receiver.

An energy signal may occupy the suppressed frequency sub-range 234 because the goal is to produce DC from the energy signal 215. Therefore, an energy transmitting device may transmit an energy signal 215 in the suppressed frequency sub-range 234. In the example of FIG. 2, the energy signal 215 occupies a portion 236 of the frequency sub-range 234. In one embodiment, the energy signal may more efficiently deliver energy by limiting the bandwidth-spread of the energy to a narrow frequency sub-range (such as portion 236). In other words, a wireless device may recover energy from a narrow-band energy signal more efficiently than a wide-band energy signal (not shown). In other embodiments, the energy transmitting device may transmit more energy by using a larger energy signal (not shown) occupying a larger portion of the frequency sub-range 234.

In one implementation, the transmitted energy signal 215 may be a digitally spread signal transmitted at the center frequency of the channel of operation of the OFDM communication device. As a point of reference, an IEEE 802.11n/ac OFDM based WLAN system may define a suppress frequency sub-range of approximately 937.5 MHz at the center of the frequency range associated with each communication channel. In some embodiments, the energy signal may be limited to conform to government regulations. For example, the transmitted signal may have a maximum equivalent isotropically radiated power (EIRP) of 36 dBm, and a maximum of 8 dBm transmitted in any 3 kHz region of the overall energy signal bandwidth.

FIG. 3 depicts an example energy transmitting device 300 capable of transmitting an energy signal in accordance with an embodiment of this disclosure. The example energy transmitting device 300 includes communication signal transmitter 310 and communication signal receiver 312. The communication signal transmitter 310 and communication signal receiver 312 may be part of a communication unit 320 responsible for data communication over the communication channel. The communication unit 320 may also include one or more interfaces to a first antenna 311. In FIG. 3, a switch 316 is illustrated to represent a time division duplexed capability of the communication unit 320. For example, the switch 316 may represent a logical change between transmission or reception state. In some embodiments, the switch 316 may represent a logical feature and not an actual component. In various implementations, the communication signal transmitter 310 and communication signal receiver 312 may utilize one antenna, two antennas, or more than two antennas. In the example of FIG. 3, the example energy transmitting device 300 may alter between a transmitting state (using the communication signal transmitter 310) and a receiving state (using the communication signal receiver 312) using the same first antenna 311.

The example energy transmitting device 300 includes an energy signal transmitter 330. The energy signal transmitter 330 is illustrated as a separate component from the communication unit 320. In some embodiments, the energy signal transmitter 330 may physically be included as a component with the communication unit 320 in an integrated energy transmitting device. The energy signal transmitter 330 may be manufactured together or separately from the communication unit 320. For example, the energy signal transmitter 330 may be a separate component that is added to an already deployed network energy transmitting device. The energy signal transmitter 330 may be collocated (as shown) with a communication unit, or may be a standalone energy transmitting device.

In FIG. 3, the energy signal transmitter 330 is coupled to a second antenna 331. The energy signal transmitter 330 may share the first antenna 311 in some embodiments.

The energy signal transmitter 330 may receive power 360 from a power source (such as a powerline, or battery) and transmit the energy signal to convey energy to the wireless device (not shown).

In one embodiment, the energy signal transmitter 330 may also receive information 350 that can be modulated onto the energy signal. For example, the information 350 may be used to modulate an amplitude, duty cycle, pulse rate, etc. associated with the energy signal. In another example, the energy signal transmitter may embed a message in the energy signal that can be received by a suitably equipped wireless device. In another example, the energy signal may include a broadcast message such as a synchronization message—where it may contain a time-value representing a notion of global time. The embedding of synchronization information in the energy signal transmitter could facilitate lower overall system energy consumption, not requiring the communication signal receiver on the wireless device to wake up to receive the synchronization information. In another example, the energy signal may include a directed message, such as a paging message, to a wireless device. For example, the energy signal may include the address of the wireless device to cause the wireless device to wake up when paged. The embedding of paging information may facilitate overall lower energy operation of the wireless device, causing a communication subsystem of the wireless device to wake up only when a valid paging signal is received. In other examples, other types of information may be embedded in the energy signal, such as status of buffered traffic at the energy transmitting device, a traffic indication map, or the like.

The example energy transmitting device 300 may be equipped with the capability to mitigate self-interference caused by the energy signal on the communication signal. Self-interference effects of the energy signal may be mitigated using passive cancellation techniques (such as filtering) or active cancellation techniques. For example the communications signal receiver 312 can implement filtering to mitigate the effects of the transmitted energy signal on the communications receiver performance.

The example energy transmitting device 300 may include feedback path between the energy signal transmitter 330 and the communication unit 320. The feedback path may be used to convey an energy signal transmitter cancellation signal 332 from the energy signal transmitter 330. The energy signal transmitter cancellation signal 332 may be used for passive or active cancellation of the energy signal from the communication signal receiver path. The communication unit 320 may include a cancellation unit 314 configured to actively cancel the energy signal from a received communication signal. Using the interference cancellation, the example energy transmitting device 300 may mitigate a portion of impairment caused by the transmission of the energy signal. In various embodiments, the energy signal transmitter cancellation signal 332 may be drawn at base-band, analog, inter-mediate frequency (IF), radio-frequency (RF) or at multiple points in the signal processing chain. Likewise, the cancellation unit 314 shown in FIG. 3 may be incorporated at RF, IF, analog or baseband, or in multiple stages in the communication signal receiver path. Alternatively, the self-interference effects of the energy-signal on the communication signal receiver 312 may be mitigated via passive cancellation techniques, such as filtering. It would be apparent that the mitigation of the energy signal in the receive path of the communication signal receiver, may be realized via a combination of active and passive techniques described in previous embodiments.

The example energy transmitting device 300 of FIG. 3 depicts a clear channel assessment signal 342 going from the communication signal receiver 312 to the communication signal transmitter 310. For example, the example energy transmitting device 300 may perform a “listen before talk” procedure, as is characteristic of devices such as WLAN access points operating in unlicensed spectrum. A communication signal typically comprises a preamble, followed by data transmission. The preamble is typically transmitted using a more robust modulation and coding scheme (MCS) such as binary phase shift keying (BPSK), while data is transmitted at higher MCS's to allow for higher throughputs. The communication signal receiver 312 may use the preamble to detect the presence of a communication signal on the communication channel, establish time and frequency synchronization at the communication signal receiver 312, perform channel estimation, and initialize the communication signal receiver 312 for receiving and demodulating the data portion of the transmission.

In a contention based scheme, such as WLAN, the communication signal receiver 312 may use the preamble to detect a received communication signal. In accordance with an embodiment of this disclosure, upon detecting a valid preamble of an incoming communication signal, the example energy transmitting device 300 may disable the transmission of the energy signal by the energy signal transmitter 330, so as to improve the reliability of demodulation of the data-portion of the communication signal. The communication signal receiver 312 may enable the energy transmitter on completion of incoming communication signal or packet.

The example energy transmitting device 300 may use other appropriate controls (not shown) between the communication signal transmitter 310, communication signal receiver 312, and energy signal transmitter 330 to manage transmission of the energy signal. For example, in an embodiment, the energy signal transmitter 330 may disable transmission of the energy signal while the communication channel is active. In another embodiment, the energy signal transmitter 330 may be configured to transmit the energy signal concurrently with the communication signal transmitter 310 transmitting an outbound communication signal. In another embodiment, the energy signal transmitter 330 may be controlled to transmit the energy signal during times when the communication signal transmitter 310 is transmitting to particular wireless devices, or when the communication signal receiver 312 is receiving from particular wireless devices.

FIG. 4 depicts an example wireless device 400 capable of receiving an energy signal in accordance with an embodiment of this disclosure. The example wireless device 400 includes a communication signal transmitter 410 and communication signal receiver 412, which together may form part of a communication unit 420. Similar to the example energy transmitting device 300 in FIG. 3, the example wireless device 400 in FIG. 4 includes a switch 416 representing a change in communications receive state and transmit state, and a first antenna 411. The example wireless device 400 may also have a clear channel assessment signal 442 going from the communication signal receiver 412 to the communication signal transmitter 410 used as part of a “listen before talk” procedure.

The example wireless device 400 is also equipped with an energy signal receiver 430 capable of receiving an energy signal. The energy signal may be received via a second antenna 431 or from the first antenna 411 (if a suitable coupling from first antenna 411 to energy signal receiver 430 was included). The energy signal receiver 430 may harness the energy from the energy signal and provide power 460 to a battery 470 or power 461 to the communication unit 420. If present, the battery 470 may store the power 460 from the energy signal receiver 430 and provide power 461 to the communication unit 420 at a later time.

The energy signal receiver 430 may also recover information 450 from the energy signal and provide the information 450 to the communication signal receiver 412. For example, the information 450 may include synchronization data, clock timing, paging data, or the like.

An energy signal suppression unit 414 may be employed in the communication signal receiver 412 path. The energy signal suppression unit 414 may be realized using a high dynamic-range front-end, enhanced filtering, active cancellation or other features, such that the energy signal suppression unit 414 can mitigate the effects of the energy signal on the performance of the communication signal receiver 412. The energy signal suppression unit 414 may be implemented at RF, IF, analog or base-band stages of processing, or as a combination of the above. The energy signal or a representation 432 of the energy signal may be used by the energy signal suppression unit 414 to reconstruct the interference to be removed by the energy signal suppression unit 414.

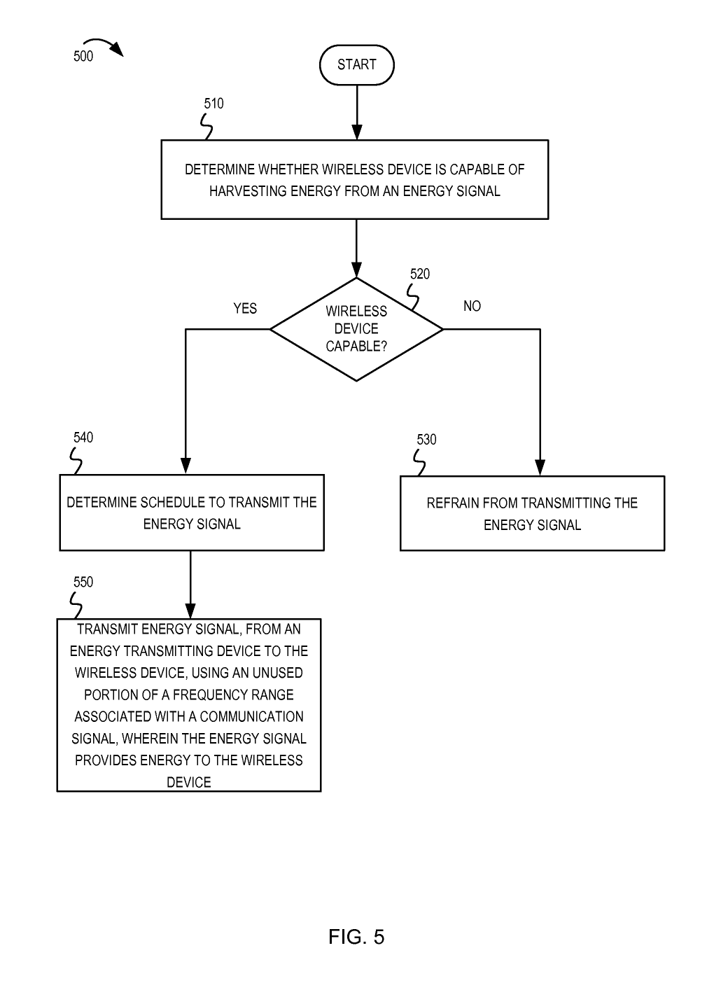

FIG. 5 is a flow diagram 500 (“flow”) associated with transmission of the energy signal in accordance with an embodiment of this disclosure.

At block 510, an energy transmitting device may determine whether a wireless device is capable of harvesting energy from an energy signal. For example, the energy transmitting device may transmit a service advertisement indicated that the energy transmitting device can transmit the energy signal. The energy transmitting device may scan or solicit capability information from one or more wireless devices associated or wirelessly coupled to the energy transmitting device. In one embodiment, the energy transmitting device may receive an indicator from a wireless device indicating whether or not the wireless device has a compatible energy signal receiver to harvest energy from an energy signal.

At decision 520, the flow may branch depending on whether the wireless device is capable of harvesting energy from the energy signal. If the wireless device is not capable of harvesting the energy, then the flow continues to block 530. At block 530, the energy transmitting device may refrain from transmitting the energy signal. However, at decision 520, if the wireless device (at least one wireless device) is capable of harvesting the energy, then the flow continues to block 540.

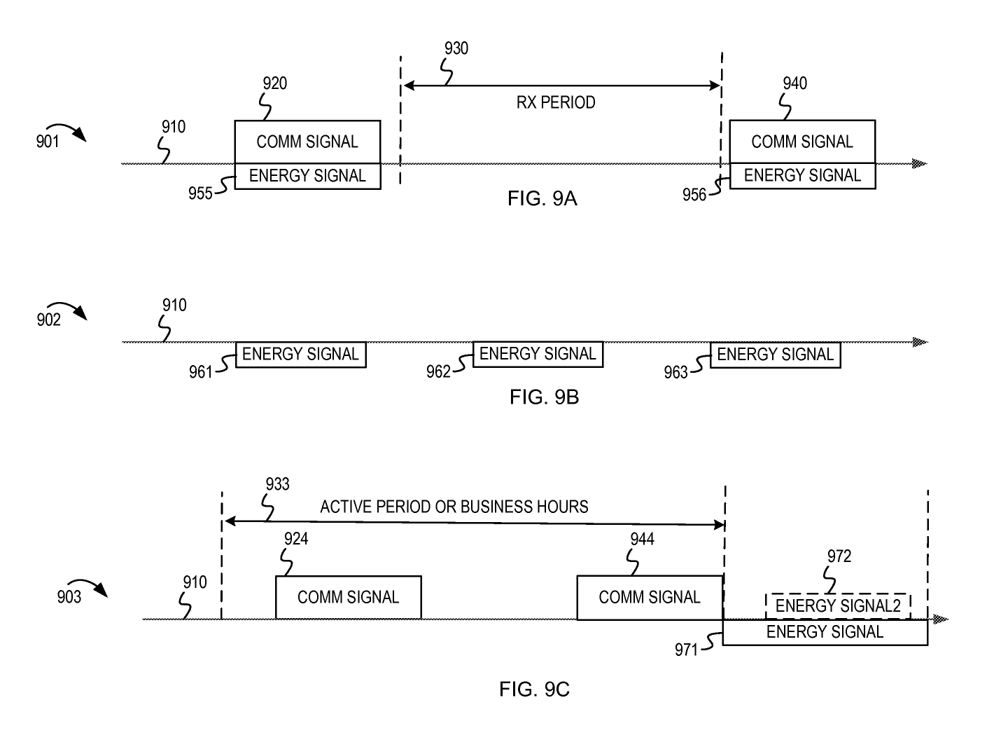

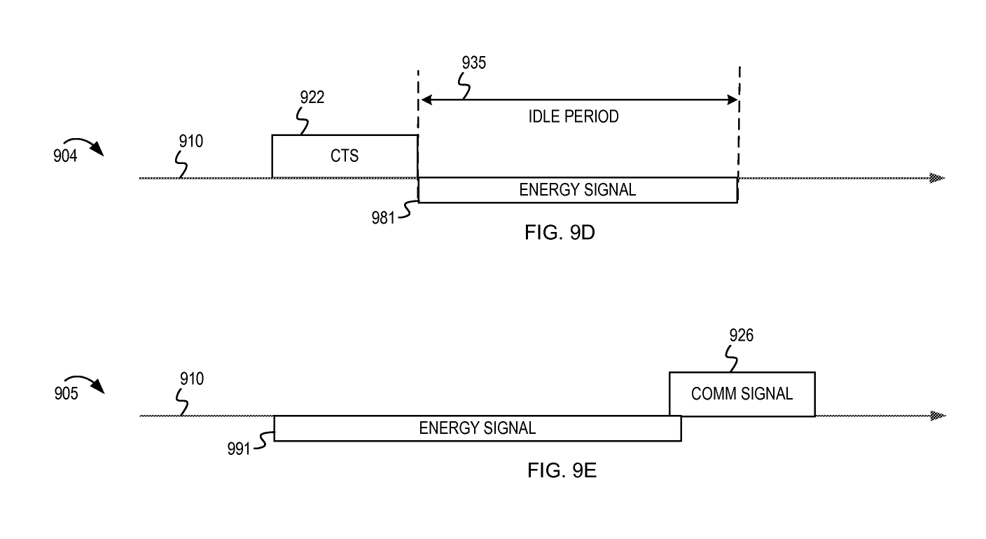

At block 540, the energy transmitting device may determine a schedule to transmit the energy signal. Several example schedules are described in FIGS. 9A-9C of this disclosure. Example of schedules may include continuously transmitting the energy signal, transmitting the energy signal according to a duty cycle, transmitting the energy signal concurrently with transmitted communication signals, transmitting the energy signal only during particular periods of inactivity or during non-business hours. In a scheduled communication channel (such as a time division multiplexed communication channel with assigned time slots), transmission of the energy signal may be disabled during reception periods of the communication signal receiver. The schedule to transmit the energy signal may be a predetermined schedule or may be dynamically determined by a scheduler.

At block 550, the energy transmitting device may transmit the energy signal, to the wireless device, using an unused portion of a frequency range associated with a communication signal. The energy signal provides energy that can be harvested by an energy signal receiver of the wireless device.

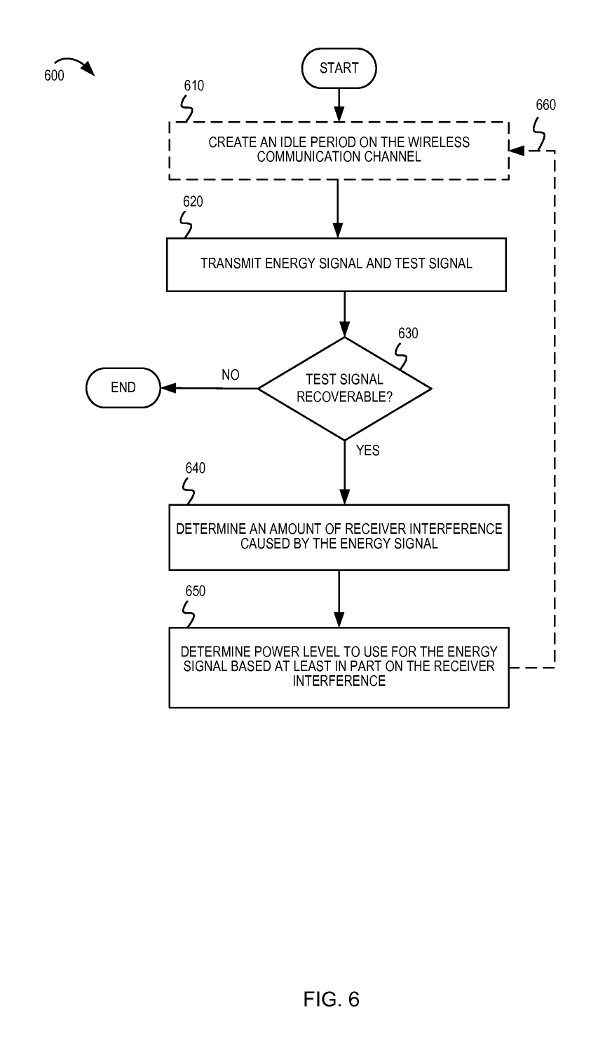

FIG. 6 is a flow diagram 600 (“flow”) in which power of an energy signal may be adjusted in accordance with an embodiment of this disclosure. An energy transmitting device may adapt the level of the transmitted energy signal based on channel conditions, channel activity, throughput, or other conditions of the communication channel. For example, the energy transmitting device may adjust an amount of energy to include in a transmitted energy signal based at least in part on the self-interference caused by transmitting the energy signal. In the flow, an energy transmitting device may determine power level to use for the energy signal based at least in part on the receiver interference. The power level may be changed or adjusted as a result of a subsequent test or configuration.

Beginning at block 610, the energy transmitting device may create an idle period on the wireless communication channel. For example, the energy transmitting device may transmit a clear to send (CTS) message (e.g., a CTS to self), an energy signal notification message, or other message to cause other energy transmitting device and wireless devices to refrain from transmitting on the communication channel for a period of time defined as an idle period.

At block 620, during the idle period, the energy transmitting device may transmit the energy signal and, optionally a test communication signal.

At decision 630, the energy transmitting device may determine whether the test communication signal is recoverable (e.g., received and decoded) by the communication signal receiver of the energy transmitting device. If the test communication signal cannot be recovered, the flow may end and the test deemed inconclusive. If the test communication signal can be recovered, the flow may continue to block 640.

At block 640, the energy transmitting device may determine an amount of receiver interference caused by the energy signal. For example, the energy transmitting device may compare the received test communication signal with the transmitted test communication signal. Alternatively, the energy transmitting device may determine the amount of receiver interference caused by the energy signal by receiving measurement data from a remote receiving device.

At block 650, the energy transmitting device may determine a power level to use for the energy signal based at least in part on the receiver interference. For example, the receiver interference may be compared to a threshold to determine if it is below the threshold. If the receiver interference is above the threshold, the power level of the energy signal may be reduced. In other embodiments, a look up table may be used to select the power level of the energy signal for subsequent transmissions based at least in part on the receiver interference determined for the current test.

The test may repeat (shown as line 660) as often as needed to determine a power level setting to use for the energy signal. Alternatively, once a power level is determined, the power level may be used for a period of time, and upon expiration of the period of time, the test may be performed again. In some implementations, the features in blocks 610-650 may be part of a calibration process associated with configuring the energy signal.

In some embodiments, adjustment to the power level of the energy signal may be performed without a closed loop test. For example, the energy transmitting device may receive periodic receiver feedback from a wireless device during normal operation. The periodic receiver feedback may provide a quality estimate or throughput estimate associated with the communication channel. The energy transmitting device may adjust the power level of the energy signal based at least in part on the periodic receiver feedback.

In another embodiment, some portions of flow 600 may be performed by a remote receiving device. Described above, measurements related to the energy signal and receiver interference may be made locally by the energy transmitting device. However, in other embodiments, the measurements related to the energy signal and receiver interference may be performed at a remote receiving device that communicates the measurements (or results) to the energy transmitting device.

Generally, power level of the energy signal may be reduced when the periodic receiver feedback or the receiver interference (from block 640) indicates a lower quality at the receiver. Lowering the power level of the energy signal may increase the quality of the received signal.

In another embodiment, the energy transmitting device may adjust the power level and duty cycle of the energy signal based on time of the day. For example, the energy transmitting device may transmit the energy signal at times of lighter network traffic or human presence.

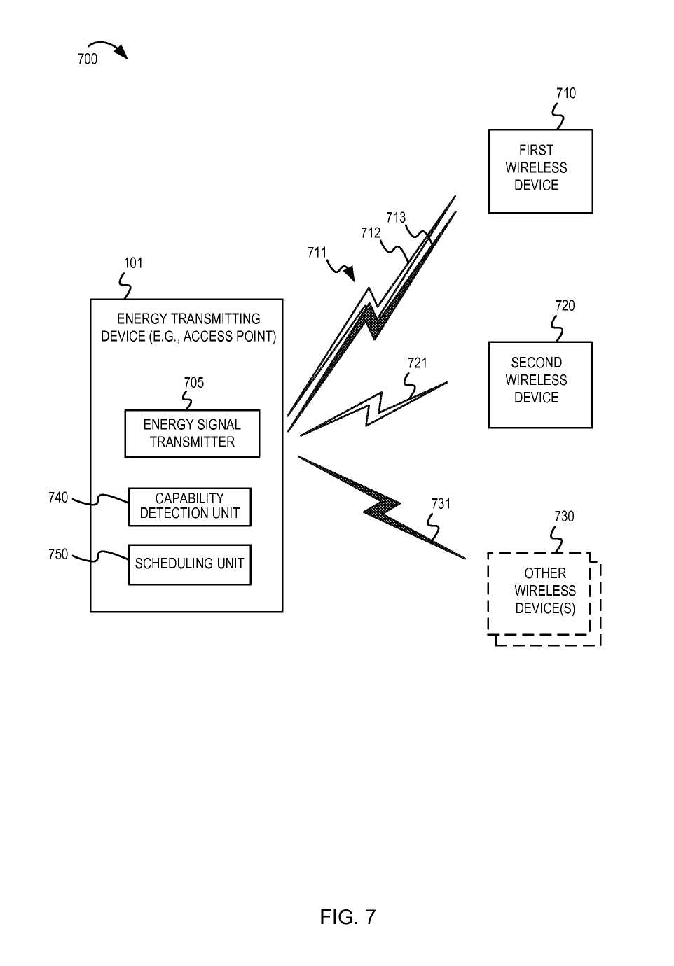

FIG. 7 depicts an example system 700 in which an energy transmitting device 101 may selectively transmit the energy signal to one or more wireless devices, such as first wireless device 710, second wireless device 720, and other wireless device 730. In FIG. 7, the energy transmitting device 101 includes an energy signal transmitter 705 configured to transmit the energy signal. The energy transmitting device 101 also includes a capability detection unit 740 and scheduling unit 750. The capability detection unit 740 may be configured to determine which wireless device(s) are capable of harvesting energy from the energy signal.

The capability detection unit 740 may determine that a wireless device is capable of harvesting energy from the energy signal by a variety of ways. For example, the capability detection unit 740 may receiver an explicit request from a wireless device for the energy signal. Alternatively, the capability detection unit 740 may transmit a service advertisement (unicast or broadcast) indicating that the energy transmitting device 101 can transmit the energy signal if any wireless devices are capable of utilizing the energy signal. In another embodiment, the wireless devices 710, 720, 730 may be configured to transmit a capability message having an indicator for indicating whether or not the wireless device supports the wireless energy techniques described herein. Other ways of determining whether the wireless devices can harvest energy from an energy signal may be readily conceived by persons of skill in the art.

In the example of FIG. 7, the first wireless device 710 and other wireless device 730 may be capable of receiving the energy signal, while second wireless device 720 may not be capable of receiving the energy signal. In one embodiment, the energy transmitting device 101 may adjust (e.g., decrease) the power level and the duty-cycle of the energy signal based at least in part on detecting that the second wireless device 720 (also referred to as non-supporting wireless device, non-capable wireless device, legacy wireless device) does not support the wireless energy signal capability. Non-supporting wireless devices may be impaired by the transmission of the energy signal. Therefore, in an embodiment, the energy transmitting device 101 may reduce power level of the energy signal, or refrain from transmitting the energy signal, when non-supporting devices are in operation within range of the energy transmitting device 101. Alternatively, beam forming may be used to direct the energy signal towards capable wireless devices and away from non-capable wireless devices.

In FIG. 7, the capability detection unit 740 has determined that first wireless device 710 and other wireless device 730 are capable of processing the energy signal. The energy signal transmitter 705 may then include the energy signal during times when the first wireless device 710 and other wireless device 730 are able to use the energy signal. For example, a scheduling unit 750 may determine a schedule for transmitting the energy signal. In one example, a data transmission is scheduled for delivery to the first wireless device 710. At a time when the data transmission is transmitted (as a communication signal 712), the energy signal transmitter 705 may transmit the energy signal 713. The communication signal 712 and energy signal 713 may be concurrently transmitted as a combined energy signal and communication signal 711 to the first wireless device 710.

When the scheduling unit 750 determines that a data transmission is to be delivered to the second wireless device 720, which is not capable of processing the energy signal, the energy signal transmitter 705 may refrain from including the energy signal. Instead, the energy transmitting device 101 may transmit only the communication signal 721 to the second wireless device 720.

In another example, no data transmissions may be scheduled for delivery, but the scheduling unit 750 may determine a schedule for transmitting the energy signal. For example, the scheduling unit 750 may specify a reserved time slot or resource assignment for the energy signal. During the scheduled time, the energy signal transmitter 705 may transmit the energy signal 731. In one embodiment, the energy transmitting device 101 may create an opportunity to transmit the energy signal by sending a clear-to-send (CTS)-to-self signal, causing surrounding devices to hold off from any transmission of their own.

In another embodiment, the energy transmitting device 101 may employ the use of MIMO beam-forming to transmit a focused energy signal to a wireless device (such as first wireless device 710). The energy transmitting device 101 may employ the use of single-user or multi-user MIMO beam-forming to transmit the focused energy signal simultaneously to a plurality of wireless devices (such as first wireless device 710 and other wireless device 730). For MIMO beam-forming or multi-user MIMO beamforming, the energy transmitting device 101 may obtain beam-forming weights from the intended wireless device(s) via various channel state feedback request schemes, and estimate the beam-forming weights to be applied to the energy signal by interpolation of channel state information/beam-forming weights of the adjacent data signal tones. Recognizing that the channel state information sent by the wireless device may not incorporate channel state of the unused channel center frequency of the communication signal (that may be used for transmission of the energy signal), the energy transmitting device may employ interpolation to estimate the channel state information and/or the transmit beam-forming weights based on the channel state of the adjacent data tones. To reduce overhead associated with the transmission of beam-forming weights, the energy transmitting device may schedule the transmission of the beam-formed energy signal to occur concurrently with a beam-formed communication signal directed to a wireless device.

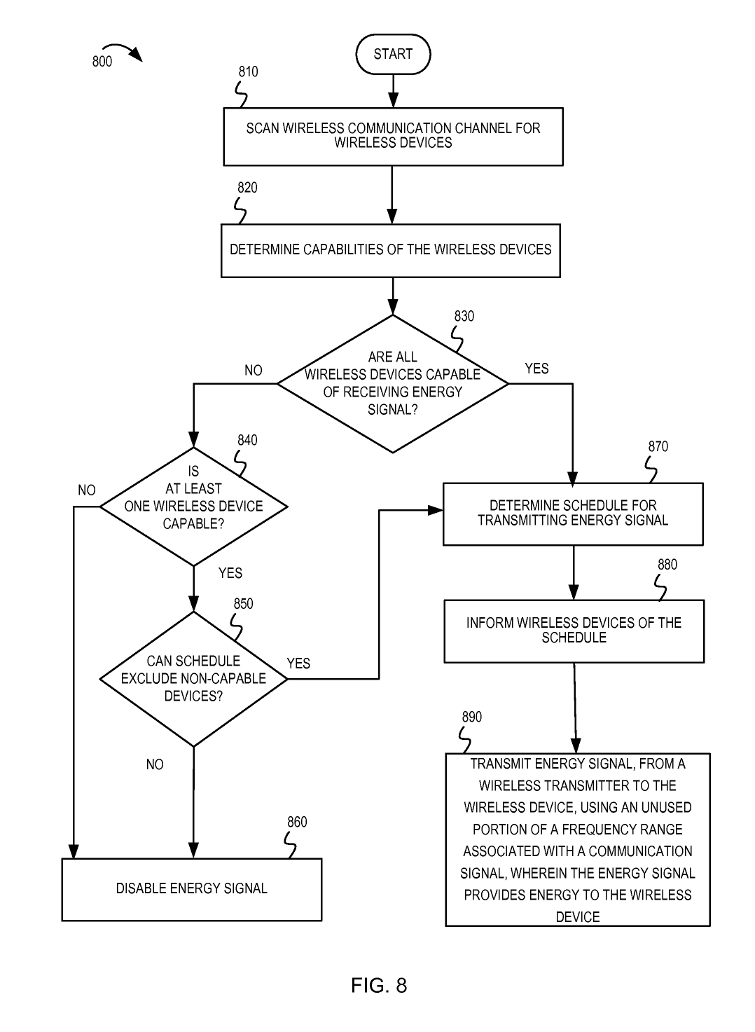

FIG. 8 is a flow diagram 800 (“flow”) in which transmitting the energy signal may be dependent on capability of wireless devices and scheduling. An energy transmitting device may make a determination of the presence of non-supporting devices and control transmission of an energy signal to avoid impairing non-supporting devices.

At block 810, the energy transmitting device may scan a wireless communication channel for wireless devices. The energy transmitting device may already be aware of wireless devices based on a wireless association between the AP (energy transmitting device) and the various wireless devices. In one embodiment, the energy transmitting device may perform a wireless scan to become aware of other wireless devices that may be impacted by an energy signal even if the wireless devices do not already have a wireless association with the energy transmitting device. In some embodiments, the energy transmitting device may scan a current frequency band or communication channel, as well as adjacent communication channels.

At block 820, the energy transmitting device may determine capabilities of the wireless devices. For example, the energy transmitting device may query each wireless device. In one embodiment, the energy transmitting device may send an overhead or broadcast message and collect responses from at least a subset of the wireless devices indicating whether or not the subset of wireless devices support wireless energy transfer. In another embodiment, a lack of response from a wireless device may be indicative (by omission) that the wireless device does not support wireless energy.

At decision 830, the energy transmitting device may determine whether all wireless devices are capable of receiving the energy signal. If all wireless devices in the vicinity of the energy transmitting device are capable of receiving the energy signal, the flow continues to block 870. However, if not all of the wireless devices are capable of receiving the energy signal, the flow continues to decision 840.

At decision 840, the energy transmitting device determines whether at least one wireless device is capable of receiving the energy signal. If there is no wireless device that is capable of receiving the energy signal, the flow continues to block 860. However, if there is at least one wireless device capable of receiving the energy signal, the flow continues to decision 850.

At decision 850, the energy transmitting device determines whether a schedule could be developed such that capable devices can receive the energy signal, while the schedule excludes times that may interfere with non-capable devices (e.g., the schedule excludes the non-capable devices). If such a schedule cannot be developed, the flow continues to block 860. However, if a scheduled can be developed that allow transmission of the energy signal to the capable devices without interfering with the non-capable devices, the flow continues to block 870.

At block 860, the energy transmitting device may disable the energy signal. Thus, in the absence of wireless devices that are capable of receiving and utilizing the energy signal, the energy transmitting device may disable the energy signal transmitter. In one alternative embodiment, the energy transmitting device may transmit a minimal amount of energy in a reduced energy signal. The reduced energy signal may be sufficient to provide initial energy for new energy receiving capable device that may roam into vicinity of the energy transmitting device, while still being at a low energy level so that it does not interfere with the non-capable devices. The energy transmitting device may also estimate receiver interference caused to a non-capable wireless device as a result of the energy signal, and adjust a power level of the energy signal to reduce estimated receiver interference below a threshold.

At block 870, the energy transmitting device may determine a schedule for transmitting the energy signal. As an example, the schedule may be developed to transmit the energy signal during time periods that will not interfere with normal operation of the non-capable device(s) (if any). Example schedules are described in FIGS. 9A-9C.

At block 880, the energy transmitting device may inform one or more wireless devices regarding the energy signal schedule. For example, the energy transmitting device may transmit a broadcast message with information indicating a periodic or repeating time period for the energy signal. Alternately, the energy transmitting device may send direct messages to each wireless device to indicate a time period or resource assigned for the energy signal. Alternately the energy transmitting device may reserve a resource on the medium using a mechanism such as CTS-to-self or its equivalents to create a period of time during which the energy transmitting device transmits the energy signal.

At block 890, the energy transmitting device may transmit the energy signal in accordance with the schedule. The energy signal may be transmitted to a particular wireless device (such as using beamforming). Alternatively the energy signal may be transmitted as an omnidirectional energy signal for multiple wireless devices to receive. The energy signal may be transmitted in an unused portion of a frequency range associated with communication signals of the wireless network.

FIGS. 9A-9E illustrate example timing diagrams with various example schedules for transmitting energy signals and communication signals on a communication channel 910.

FIG. 9A shows a first example schedule 901 in which the energy transmitting device may be configured to transmit the energy signal concurrently with communication signals. For example, during a first transmission period, the energy transmitting device may transmit communication signal 920 and energy signal 955 concurrently. During a receive period 930, the energy transmitting device may be listening for received transmissions and may refrain from transmitting the energy signal. Then during a second transmission period, the energy transmitting device may transmit communication signal 940 and energy signal 956 concurrently. In this example, the energy transmitting device may transmit an energy signal each time the energy transmitting device initiates transmission of a communication signal. Alternatively, the energy transmitting device may only transmit the energy signal when the communication signal is directed to a wireless device that is capable of harvesting energy from the energy signal.

FIG. 9B shows a second example schedule 902 in which the energy transmitting device may be configured to transmit the energy signal according to a fixed periodic schedule (or duty cycle). The energy transmitting device may transmit energy signals 961, 962, 963 in accordance with the determined schedule, regardless of whether the energy transmitting device is concurrently transmitting or receiving communication signals 922, 942.

FIG. 9C shows a third example schedule 903 in which the energy transmitting device may be configured to schedule the energy signal during off business hours or based on activity of the communication channel. The timing diagram shows an active period or business hours 933, during which communication signals 924, 944 may be typically transmitted or received. For example, an office building may have employees using the wireless network during normal business hours. During this period of time, the energy transmitting device may refrain from transmitting the energy signal. After the normal business hours, or during off-peak hours, the energy transmitting device may transmit the energy signal 971. For example, the energy transmitting device may transmit the energy signal from midnight to 5 a.m. in an office building that is typically vacant during those times. During that time, the wireless devices may receive the energy signal, obtain the energy from the energy signal 971, and recharge a battery of the wireless device. This may be useful, for example, with sensors, actuators, motion detectors, or other wireless devices used in an office building. In some embodiments, the energy transmitting device may transmit a second energy signal 972 or may transmit an energy signal having higher power levels when a building is known to be vacant (e.g., lack of motion as detected by motion detectors). In another embodiment, the energy transmitting device may transmit an energy signal responsive to a quantity of end user wireless devices that are currently wirelessly coupled to an access point at or near the energy transmitting device. For example, the energy transmitting device may determine how many end user wireless devices are currently wireless associated with the access point and enable the energy signal if the quantity of end user wireless devices are below a threshold, or when there are no end user wireless devices.

FIG. 9D shows a fourth example schedule 904 in which the energy transmitting device may be configured to transmit the energy signal 981 during an idle period 935. The idle period may be created in response to a message 922 (such as a CTS-to-self) transmitted by an access point at or near the energy transmitting device. The message 922 may indicate a duration for the idle period 935.

FIG. 9E shows a fifth example schedule 905 in which the energy transmitting device may be configured to transmit the energy signal 991 continuously for a large burst period that gets suspended upon transmission of a communication signal 926. For example, the energy transmitting device may detect transmission of a communication signal transmitted by a communication signal transmitter of the energy transmitting device and discontinue the energy signal responsive to transmitting the communication signal. Alternatively, the energy transmitting device may detect a communication signal received from another device and discontinue the energy signal responsive to the received communication signal.

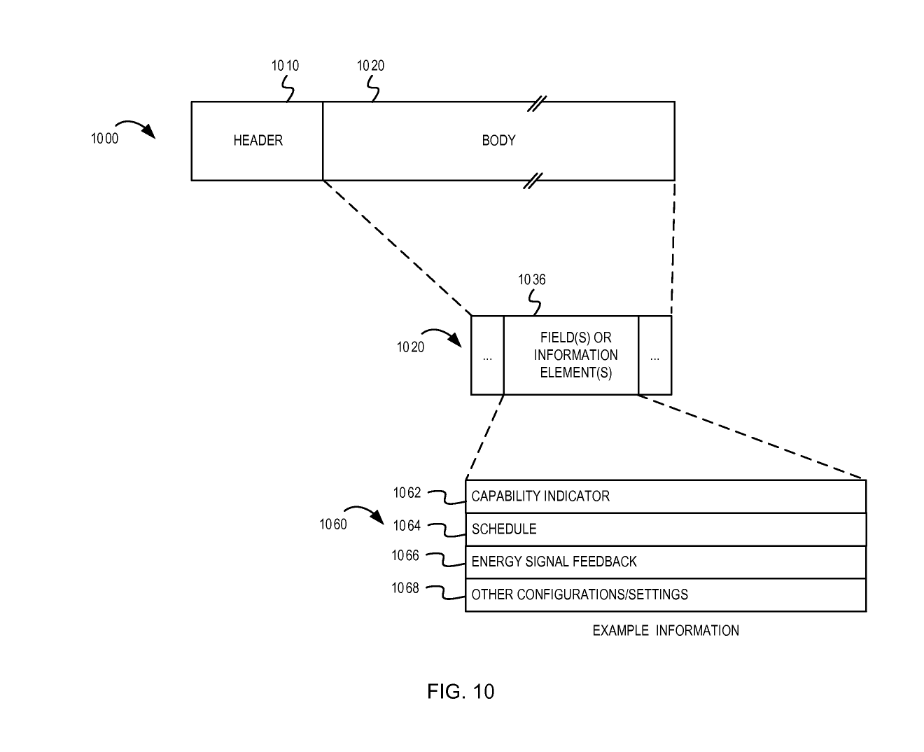

FIG. 10 depicts an example message format 1000 in accordance with an embodiment of this disclosure. The example message format 1000 includes a header 1010 and body 1020. The body 1020 may include one or more fields or information elements 1036, such as vendor-specific information elements. Depending on the type of message, the fields or information elements 1036 may include different types of information regarding wireless energy settings 1060. For example, the body 1020 may comprise multiple information elements (not shown) including vendor specific information elements. Example wireless energy settings 1060 may include:

A capability indicator 1062 may be used in a query or response message between the energy transmitting device and the wireless device. The capability indicator may also be included in a service advertisement message or a service request message. The capability indicator may be used for either the energy transmitting device or wireless device to indicate that it supports the energy signal features described herein.

A schedule 1064 may be used in a message from an energy transmitting device to one or more wireless devices to indicate a schedule according to which the energy signal will be scheduled. Alternatively, a wireless device may include a requested schedule in a service request message.

An energy signal feedback 1066 may be used by a wireless device to provide feedback to the energy transmitting device regarding the energy signal. For example, the energy signal feedback 1066 may indicate quality of embedded information, received power level of the energy signal, amount of energy harvested from the energy signal, or receiver interference associated with the energy signal.

Other configurations/settings 1068 may be readily conceived by persons of skill in the art based on this disclosure.

FIGS. 1-10 and the operations described herein are examples meant to aid in understanding various embodiments and should not be used to limit the scope of the claims. Embodiments may perform additional operations, fewer operations, operations in parallel or in a different order, and some operations differently.

As will be appreciated by one skilled in the art, aspects of the present disclosure may be embodied as a system, method, or computer program product. Accordingly, aspects of the present disclosure may take the form of an entirely hardware embodiment, a software embodiment (including firmware, resident software, micro-code, etc.) or an embodiment combining software and hardware aspects that may all generally be referred to herein as a “circuit,” “unit” or “system.” Furthermore, aspects of the present disclosure may take the form of a computer program product embodied in one or more computer readable medium(s) having computer readable program code embodied thereon.

Any combination of one or more computer readable medium(s) may be utilized, with the sole exception being a transitory, propagating signal. The computer readable medium may be a computer readable storage medium. A computer readable storage medium may be, for example, but not limited to, an electronic, magnetic, optical, electromagnetic, infrared, or semiconductor system, energy transmitting device, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, energy transmitting device, or device.

Computer program code embodied on a computer readable medium for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, energy transmitting device (systems) and computer program products according to embodiments of the present disclosure. Each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing energy transmitting device to produce a machine, such that the instructions, which execute via the processor of the computer or other programmable data processing energy transmitting device, create means for implementing the functions/acts specified in the flowchart and/or block diagram block or blocks.

These computer program instructions may also be stored in a computer readable medium that can direct a computer, other programmable data processing energy transmitting device, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing energy transmitting device, or other devices to cause a series of operational steps to be performed on the computer, other programmable energy transmitting device or other devices to produce a computer implemented process such that the instructions which execute on the computer or other programmable energy transmitting device provide processes for implementing the functions/acts specified in the flowchart and/or block diagram block or blocks.

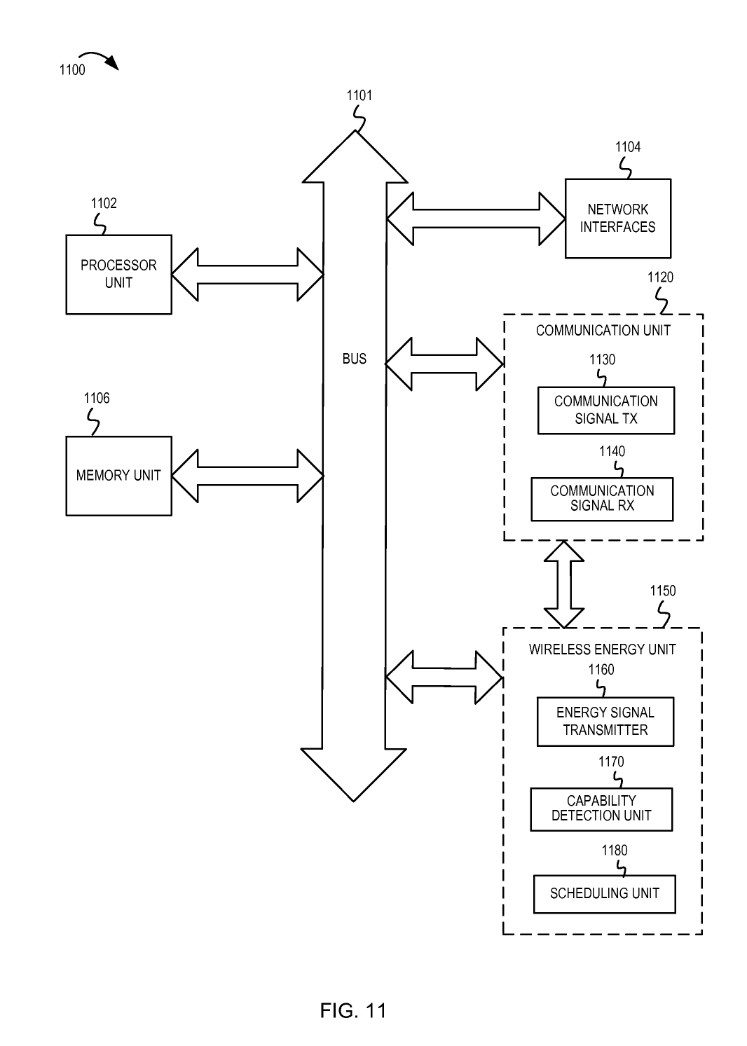

FIG. 11 is an example block diagram of one embodiment of an electronic device 1100 capable of implementing various embodiments of this disclosure. In some implementations, the electronic device 1100 may be an energy transmitting device such as an access point, home base station, peer to peer group manager, or other electronic device. In some implementations, the electronic device 1100 may be a wireless device such as a laptop computer, a tablet computer, a mobile phone, a powerline communication device, a gaming console, or other electronic systems. In some implementations, the electronic device may comprise functionality to communicate across multiple communication networks (which form a hybrid communication network). The electronic device 1100 includes a processor unit 1102 (possibly including multiple processors, multiple cores, multiple nodes, and/or implementing multi-threading, etc.). The electronic device 1100 includes a memory unit 1106. The memory unit 1106 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 1100 also includes a bus 1101 (e.g., PCI, ISA, PCI-Express, HyperTransport®, InfiniBand®, NuBus, AHB, AXI, etc.). The one or more network interfaces 1104 may be a wireless network interface (e.g., a WLAN interface, a Bluetooth® interface, a WiMAX interface, a ZigBee® interface, a Wireless USB interface, etc.) or a wired network interface (e.g., a powerline communication interface, an Ethernet interface, etc.). The electronic device 1100 may include a communication signal transmitter 1130 and communication signal receiver 1140. In some embodiments, the communication signal transmitter 1130 and communication signal receiver 1140 may together comprise part of a communication unit 1120. The communication unit 1120 may implement traditional features associated with wireless communication of data, as well as features to integrate with wireless energy transfer as described above. The electronic device 1100 may include an energy signal transmitter 1160 (or energy signal receiver, not shown). Additionally, a capability detection unit 1170 and scheduling unit 1180 may be included in the electronic device 1100. In some embodiments, the energy signal transmitter 1160, capability detection unit 1170, scheduling unit 1180 may be included together as part of a wireless energy unit 1150.

Any one of these functionalities may be partially (or entirely) implemented in hardware and/or on the processor unit 1102. For example, the functionality may be implemented with an application specific integrated circuit, in logic implemented in the processor unit 1102, in a co-processor on a peripheral device or card, etc. Further, realizations may include fewer or additional components not illustrated in FIG. 11 (e.g., video cards, audio cards, additional network interfaces, peripheral devices, etc.). The processor unit 1102, the memory unit 1106, and communication unit 1120, wireless energy unit 1150 may be coupled to the bus 1101. Although illustrated as being coupled to the bus 1101, the memory unit 1106 may be directly coupled to the processor unit 1102.

While the embodiments are described with reference to various implementations and exploitations, these embodiments are illustrative and that the scope of the disclosure and claims is not limited to them. In general, techniques for providing energy to a wireless device using an energy signal as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the disclosure.

What is claimed is:

1. A method for providing energy to a wireless device, the method comprising:
transmitting, from an energy transmitting device, an energy signal that provides energy wirelessly to the wireless device, wherein the energy signal is transmitted via an unused portion of a frequency range of a communication signal.

2. The method of claim 1, wherein the unused portion comprises a center frequency of the frequency range.

3. The method of claim 1, wherein the unused portion is offset from a center frequency of the frequency range.

4. The method of claim 1,
wherein said transmitting the energy signal is responsive to whether the wireless device is capable of harvesting energy from the energy signal.

5. The method of claim 4, further comprising:
receiving a capability indicator from the wireless device.

6. The method of claim 1, further comprising transmitting the energy signal concurrently with the communication signal.

7. The method of claim 1, further comprising transmitting the energy signal during an idle period of a wireless communication channel.

8. The method of claim 7, wherein the idle period is created in response to a message transmitted by an access point at or near the energy transmitting device, the message indicating a duration for the idle period.

9. The method of claim 1, wherein transmitting the energy signal comprises transmitting the energy signal in accordance with a schedule, the schedule associated with one of a periodic schedule, a night-time energy transmitting schedule, a burst schedule, or known idle periods of a communication channel.

10. The method of claim 1, wherein transmitting the energy signal comprises transmitting the energy signal in accordance with a criteria, the criteria associated with one of power usage of the wireless device, status of a motion detector, or a quantity of end user wireless devices that are currently wirelessly coupled to an access point at or near the energy transmitting device.

11. The method of claim 1, wherein transmitting the energy signal comprises transmitting the energy signal when during a time when a quantity of non-supporting wireless devices within a wireless coverage range of the energy transmitting device is below a threshold.

12. The method of claim 1, further comprising:
determining an amount of receiver interference caused by the energy signal; and
adjusting a power level of the energy signal based at least in part on the receiver interference.

13. The method of claim 12, wherein determining the amount of receiver interference caused by the energy signal comprises:
determining that a second wireless device is not capable of harvesting energy from the energy signal;
estimating receiver interference caused to the second wireless device as a result of the energy signal; and
adjusting a power level of the energy signal to reduce estimated receiver interference below a threshold.

14. The method of claim 1, wherein transmitting the energy signal comprises:
directing the energy signal to the wireless device using beam-forming.

15. The method of claim 1, wherein transmitting the energy signal comprises:
directing the energy signal to the wireless device using multiple-input-multiple-output (MIMO) beam-forming.

16. The method of claim 1, further comprising:
modulating information onto the energy signal.

17. The method of claim 1, wherein the communication signal is an orthogonal frequency division multiplexing (OFDM) signal.

18. The method of claim 1, wherein the energy transmitting device is an access point of a wireless local area network.

19. The method of claim 1, further comprising:
embedding time synchronization information or paging information in the energy signal.

20. An energy transmitting device capable of wirelessly providing energy to a wireless device, the energy transmitting device comprising:
a communication signal transmitter configured to transmit a communication signal within a frequency range associated with the communication signal; and
an energy signal transmitter configured to transmit an energy signal using an unused portion of the frequency range, wherein the energy signal provides energy to the wireless device.

21. The energy transmitting device of claim 20, further comprising:
a communication signal receiver configured to receive a capability indicator from the wireless device; and
a capability detection unit configured to determine whether the wireless device is capable of harvesting energy from the energy signal based at least in part on the capability indicator.

22. The energy transmitting device of claim 20, further comprising:
a scheduling unit configured to manage a schedule of when the energy signal transmitter transmits the energy signal, the schedule associated with one of a periodic schedule, a night-time energy transmitting schedule, a burst schedule, or known idle periods of a communication channel.

23. The energy transmitting device of claim 20, further comprising:
a scheduling unit configured to manage a schedule of when the energy signal transmitter transmits the energy signal in accordance with a criteria, the criteria associated with one of power usage of the wireless device, status of a motion detector, or a quantity of end user wireless devices that are currently wirelessly coupled to an access point at or near the energy transmitting device.

24. A method for charging a wireless device, the method comprising:
receiving, from an energy transmitting device, an energy signal via an unused portion of a frequency range associated with a communication signal; and
obtaining energy from the energy signal.

25. The method of claim 24, further comprising:
transmitting a capability indicator from the wireless device, the capability indicator for indicating that the wireless device is capable of harvesting energy from the energy signal.

26. The method of claim 24, further comprising:
determining a schedule during which the energy signal may be received; and
enabling an energy signal receiver in accordance with the schedule.

27. The method of claim 24, wherein the energy obtained from the energy signal is used to operate a communication unit that receives the communication signal.

28. A wireless device comprising:
a communication signal receiver configured to receive a communication signal within a frequency range associated with the communication signal; and
an energy signal receiver configured to receive an energy signal via an unused portion of the frequency range, wherein the energy signal provides energy to the wireless device.

29. The wireless device of claim 28,
wherein the energy signal receiver is configured to extract a paging message from the energy signal, and
wherein the communication signal receiver is configured to utilize a low power state prior to waking up responsive to the paging message directed to the wireless device.

30. The wireless device of claim 28, further comprising:
energy signal suppression circuitry to remove at least a portion of the energy signal from communication signal.
